(19) United States
(12) Patent Application Publication
(10) Pub. No.: US 2025/0168410 A1
(43) Pub. Date: May 22, 2025

(54) DRAP AND EDRAP IN THE ISOBMFF

(71) Applicant: Bytedance Inc., Los Angeles, CA (US)

(72) Inventor: Ye-Kui Wang, San Diego, CA (US)

(21) Appl. No.: 19/033,229

(22) Filed: Jan. 21, 2025

Related U.S. Application Data
(63) Continuation of application No. PCT/US2023/028056, filed on Jul. 18, 2023.
(60) Provisional application No. 63/390,184, filed on Jul. 18, 2022.

(51) Int. Cl. H04N 19/70; H04N 19/132; H04N 19/172

(52) U.S. Cl. CPC H04N 19/70; H04N 19/132; H04N 19/172

(57) ABSTRACT

A method of processing media data. The method includes determining, for a dependent random access point (DRAP) sample, a first sequence of samples; and performing a conversion between media data and a media data file based on the determining. The first sequence of samples consists of the following samples in order: 1) a closest preceding stream access point (SAP) sample of type 1, type 2, or type 3; 2) the DRAP sample; and 3) all samples following the DRAP sample in both decoding order and output order in a first track.

### CROSS-REFERENCE TO RELATED APPLICATIONS

This application is a continuation of International Patent Application No. PCT/US2023/028056, filed on Jul. 18, 2023, which claims the priority to and benefits of U.S. Provisional Patent Application No. 63/390,184 filed on Jul. 18, 2022. The aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

The present disclosure is related to media file formats. Specifically, the present disclosure is related to improved support of dependent random access point (DRAP) and extended dependent random access point (EDRAP) in the International Organization for Standardization (ISO) base media file format (ISOBMFF). The ideas may be applied individually or in various combination, to media files according to any media file formats, e.g., the ISOBMFF and file formats derived from the ISOBMFF.

A first aspect relates to a method for processing video data, comprising: generating a sequence of samples (sampleSeq) comprising a closest preceding stream access point (SAP) of type 1, type 2, or type 3, a first dependent random access point (DRAP) sample (sampleA), and all samples following the first DRAP sample in both decoding order and output order in a track including at least one second DRAP sample (sampleB); ensuring, for each of the second DRAP samples in the sequence of samples, that all data for processing the second DRAP sample is accessible; and performing a conversion between a video comprising the video data and a bitstream of the video data based on the data.

A second aspect relates to another method for processing video data, comprising: generating a sequence of samples (sampleSeq) comprising a closest preceding stream access point (SAP) of type 1, type 2, or type 3, a first extended dependent random access point (EDRAP) sample (sampleA) identified by ref_edrap_idx_delta[i] for i in the range of 0 to num_ref_edrap_samples−1, inclusive, in decoding order, and all samples following the first EDRAP sample in both decoding order and output order in a track including at least one second EDRAP sample (sampleB); ensuring, for each of the second EDRAP samples in the sequence of samples, that all data for processing the second EDRAP sample is accessible; and performing a conversion between a video comprising the video data and a bitstream of the video data based on the data.

A third aspect relates to an apparatus for processing video data, comprising: a processor; and a non-transitory memory with instructions thereon, wherein the instructions upon execution by the processor, cause the processor to perform the method of the first or second aspects.

A fourth aspect relates to a non-transitory computer readable medium comprising a computer program product for use by a video coding device, the computer program product comprising computer executable instructions stored on the non-transitory computer readable medium such that when executed by a processor cause the video coding device to perform the method of the first or second aspects.

A fifth aspect relates to a non-transitory computer-readable recording medium storing a bitstream of a video which is generated by a method performed by a video processing apparatus, wherein the method comprises the method of the first or second aspects.

A sixth aspect relates to a method for storing bitstream of a video comprising the method of the first or second aspects, wherein performing the conversion between the video comprising the video data and the bitstream of the video data comprises generating the bitstream, and wherein the method further comprises storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of coding of Intra Random Access Point (IRAP) pictures.

FIG. 2 illustrates an example of the pictures received by a decoder.

FIG. 3 illustrates an example of coding of DRAP pictures.

FIG. 4 illustrates an example of the pictures received by a decoder.

FIG. 5 illustrates an example of coding of EDRAP pictures.

FIG. 6 illustrates an example of the pictures received by a decoder.

FIG. 7 illustrates an example of EDRAP-based streaming.

FIG. 8 illustrates an example of the pictures received by a decoder.

FIG. 9 is a block diagram showing an example video processing system.

FIG. 10 is a block diagram of an example video processing apparatus.

FIG. 11 is a flowchart for an example method of video processing.

FIG. 12 is a block diagram that illustrates an example video coding system.

FIG. 13 is a block diagram that illustrates an example encoder.

FIG. 14 is a block diagram that illustrates an example decoder.

FIG. 15 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. SUMMARY

The present disclosure is related to media file formats. Specifically, the present disclosure is related to improved support of dependent random access point (DRAP) and extended dependent random access point (EDRAP) in the ISO base media file format (ISOBMFF). The ideas may be applied individually or in various combination, to media files according to any media file formats, e.g., the ISOBMFF and file formats derived from the ISOBMFF.

### 2. BACKGROUND

### 2.1 Video Coding Standards

Video coding standards have evolved primarily through the development of the well-known International Telecommunication Union—Telecommunication Standardization Sector (ITU-T) and ISO/International Electrotechnical Commission (IEC) (ISO/IEC) standards. The ITU-T produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by Video Coding Experts Group (VCEG) and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting a 50% bitrate reduction as compared to HEVC, that has been finalized by the JVET at its 19th meeting ended at Jul. 1, 2020.

The VVC standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

### 2.2 File Format Standards.

Media streaming applications are typically based on the Internet Protocol (IP), Transmission Control Protocol (TCP), and Hypertext Transfer Protocol (HTTP) transport methods, and typically rely on a file format such as the ISOBMFF. One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session. Similarly, for using an image format with ISOBMFF, a file format specification specific to the image format, such as the AVC image file format and the HEVC image file format, would be useful.

### 2.3 Random Access and its Supports in HEVC and VVC.

Random access refers to starting access and decoding of a bitstream from a picture that is not the first picture of the bitstream in decoding order. To support tuning in and channel switching in broadcast/multicast and multiparty video conferencing, seeking in local playback and streaming, as well as stream adaptation in streaming, the bitstream needs to include frequent random access points, which are typically intra coded pictures but may also be inter-coded pictures (e.g., in the case of gradual decoding refresh).

HEVC includes signaling of intra random access points (IRAP) pictures in the network abstraction layer (NAL) unit header, through NAL unit types. Three types of IRAP pictures are supported, namely instantaneous decoder refresh (IDR), clean random access (CRA), and broken link access (BLA) pictures. IDR pictures are constraining the inter-picture prediction structure to not reference any picture before the current group-of-pictures (GOP), conventionally referred to as closed-GOP random access points. CRA pictures are less restrictive by allowing certain pictures to reference pictures before the current GOP, all of which are discarded in case of a random access. CRA pictures are conventionally referred to as open-GOP random access points. BLA pictures usually originate from splicing of two bitstreams or part thereof at a CRA picture, e.g., during stream switching. To enable better systems usage of IRAP pictures, altogether six different NAL units are defined to signal the properties of the IRAP pictures, which can be used to better match the stream access point types as defined in the ISOBMFF, which are utilized for random access support in DASH.

VVC supports three types of IRAP pictures, two types of IDR pictures (one type with or the other type without associated random access decodable leading (RADL) pictures) and one type of CRA picture. These are basically the same as in HEVC. The BLA picture types in HEVC are not included in VVC, mainly due to two reasons: i) The basic functionality of BLA pictures can be realized by CRA pictures plus the end of sequence NAL unit, the presence of which indicates that the subsequent picture starts a new coded video sequence (CVS) in a single-layer bitstream. ii) There was a desire in specifying fewer NAL unit types than HEVC during the development of VVC, as indicated by the use of five instead of six bits for the NAL unit type field in the NAL unit header.

Another key difference in random access support between VVC and HEVC is the support of gradual decoding refresh (GDR) in a more normative manner in VVC. In GDR, the decoding of a bitstream can start from an inter-coded picture and although at the beginning not the entire picture region can be correctly decoded but after a number of pictures the entire picture region would be correct. AVC and HEVC also support GDR, using the recovery point supplemental enhancement information (SEI) message for signaling of GDR random access points and the recovery points. In VVC, a new NAL unit type is specified for indication of GDR pictures and the recovery point is signaled in the picture header syntax structure. A CVS and a bitstream are allowed to start with a GDR picture. This means that it is allowed for an entire bitstream to contain only inter-coded pictures without a single intra-coded picture. The main benefit of specifying GDR support this way is to provide a conforming behavior for GDR. GDR enables encoders to smooth the bit rate of a bitstream by distributing intra-coded slices or blocks in multiple pictures as opposed intra coding entire pictures, thus allowing significant end-to-end delay reduction, which is considered more important nowadays than before as ultralow delay applications like wireless display, online gaming, drone based applications become more popular.

Another GDR related feature in VVC is the virtual boundary signaling. The boundary between the refreshed region (i.e., the correctly decoded region) and the unrefreshed region at a picture between a GDR picture and its recovery point can be signaled as a virtual boundary, and when signaled, in-loop filtering across the boundary would not be applied, thus a decoding mismatch for some samples at or near the boundary would not occur. This can be useful when the application determines to display the correctly decoded regions during the GDR process.

IRAP pictures and GDR pictures can be collectively referred to as random access point (RAP) pictures.

### 2.4 Dependent Random Access Point (DRAP) Sample Group.

The ISOBMFF includes the feature of DRAP sample group. The amended specification of the DRAP sample group feature is provided below.

### 10.8 Dependent Random Access Point (DRAP) Sample Group.

### 10.8.1 Definition

A dependent random access point (DRAP) sample is a sample after which all samples in decoding order and in output order can be correctly decoded if the closest preceding SAP sample of type 1, 2, or 3 is available for reference.

NOTE 1 The closest SAP sample can be a Sync sample or marked by the SAP sample group.

NOTE 2 DRAP samples can only be used in combination with SAP samples of type 1, 2 and 3. This is in order to enable the functionality of creating a decodable sequence of samples by concatenating the preceding SAP sample with the DRAP sample and the samples following the DRAP sample in decoding order and in output order.

### 10.8.2 Syntax

```
class VisualDRAPEntry( )
extends VisualSampleGroupEntry(‘drap’) {
  unsigned int(3) DRAP_type;
  unsigned int(29) reserved = 0;
}
```

### 10.8.3 Semantics

DRAP_type is a non-negative integer. When DRAP_type is in the range of 1 to 3 it indicates the SAP_type (as specified in Annex I) that the DRAP sample would have corresponded to, had it not depended on the closest preceding SAP. Other type values are reserved.

reserved shall be equal to 0. The semantics of this subclause only apply to sample group description entries with reserved equal to 0. Parsers shall allow and ignore sample group description entries with reserved greater than 0 when parsing this sample group.

### 2.5. Extended Dependent Random Access Point (EDRAP) Based Video Coding, Storage and Streaming

### 2.5.1. The Concept and the Standard Supports

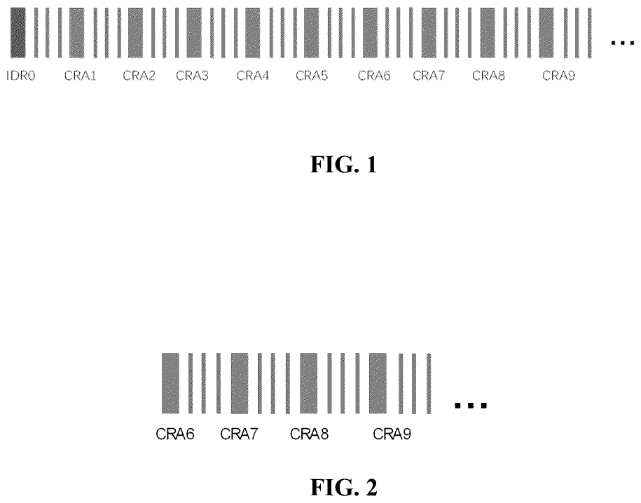

The concept of EDRAP based video coding, storage and streaming is described herein, and illustrated in the FIGS. 1-8. The application (e.g., adaptive streaming) determines the frequency of random access points (RAPs), e.g., RAP period 1s or 2s. As shown in FIG. 1, conventionally RAPs are provided by coding of IRAP pictures. FIG. 1 includes various Instantaneous Decoder Refresh (IDR) pictures and Clean Random Access (CRA) pictures.

Note that inter prediction references for the non-key pictures between RAP pictures are not shown, and from left to right is the output order.

When random accessing from CRA6, the decoder receives and correctly decodes the pictures as shown in FIG. 2.

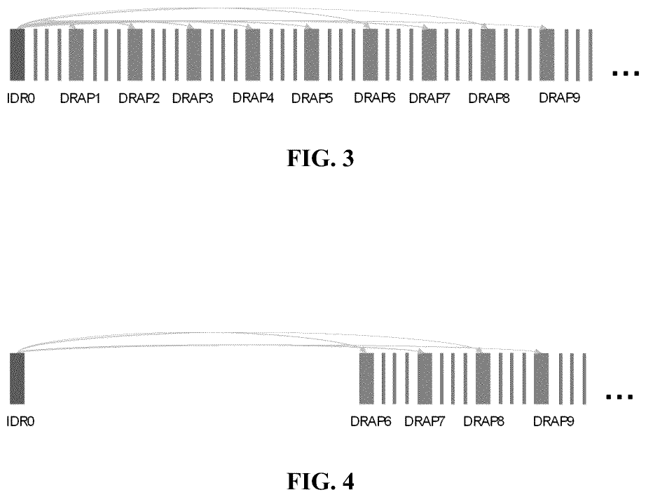

As shown in FIG. 3, the DRAP approach provides improved coding efficiency by allowing a DRAP picture (and subsequent pictures) to refer to the previous IRAP picture for inter prediction. Note that inter prediction for the non-key pictures between RAP pictures are not shown, and from left to right is the output order.

When random accessing from DRAP6, the decoder receives and correctly decodes the pictures as shown in FIG. 4.

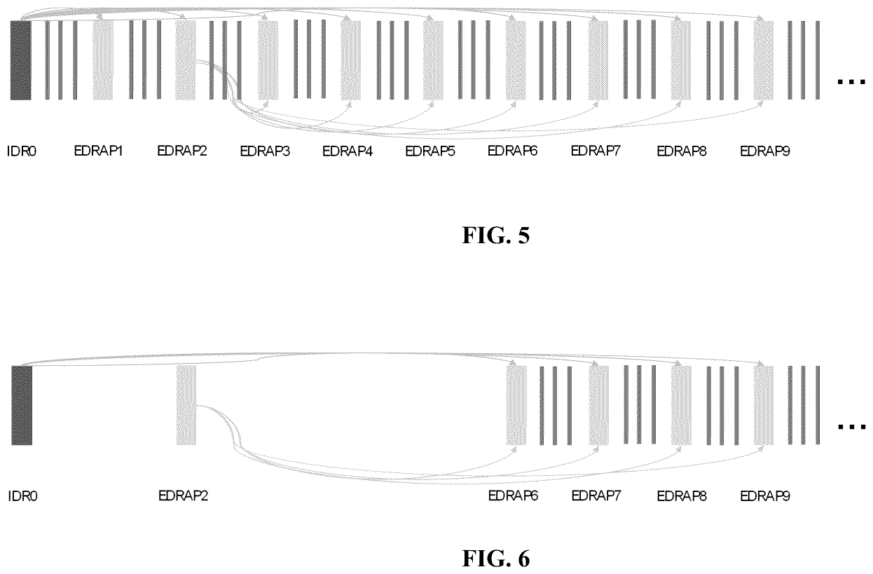

As shown in FIG. 5, the EDRAP approach provides a bit more flexibility by allowing an EDRAP picture (and subsequent pictures) to refer to a few of the earlier RAP pictures (IRAP or EDRAP). Note that inter prediction for the non-key pictures between RAP pictures are not shown, and from left to right is the output order.

When random accessing from EDRAP6, the decoder receives and correctly decodes the pictures as shown in FIG. 6.

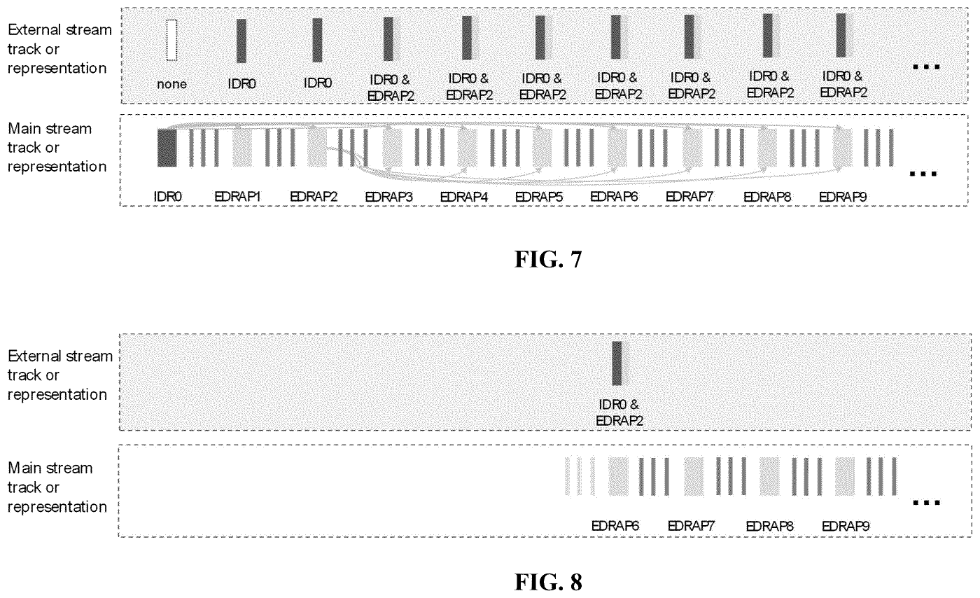

ERAP based video streaming is shown in FIGS. 7-8. When random accessing from or switching to the segment starting at EDRAP6, the decoder receives and decodes the segments as shown in FIG. 8.

At the time of the present disclosure, EDRAP based video coding is supported by the EDRAP indication SEI message in an under-development amendment to the VSEI standard, the storage part is supported by the EDRAP sample group and the associated external stream track reference in an under-development amendment to the ISOBMFF standard, and the streaming part is supported by the main stream representation (MSR) and external stream representation (ESR) descriptors in an under-development amendment to the DASH standard.

### 2.5.2. The EDRAP Indication SEI Message

An amendment to the VSEI standard is being developed. The latest draft specification of this amendment includes the specification of the EDRAP indication SEI message.

The syntax and semantics of the EDRAP indication SEI message are as follows.

| extended_drap_indication( payloadSize ) { | Descriptor |
|---|---|
| edrap_rap_id_minus1 | u(16) |
| edrap_leading_pictures_decodable_flag | u(1) |
| edrap_reserved_zero_12bits | u(12) |
| edrap_num_ref_rap_pics_minus1 | u(3) |
| for( i= 0; i <= edrap_num_ref_rap_pics_minus1; i++ ) | |
| edrap_ref_rap_id[ i ] | u(16) |
| } | |

The picture associated with an EDRAP indication SEI message is referred to as an EDRAP picture.

The presence of the EDRAP indication SEI message indicates that the constraints on picture order and picture referencing specified in this subclause apply. These constraints can enable a decoder to properly decode the EDRAP picture and the pictures that are in the same layer and follow it in both decoding order and output order without needing to decode any other pictures in the same layer except the list of pictures referenceablePictures, which consists of a list of IRAP or EDRAP pictures in decoding order that are within the same coded layer video sequence (CLVS) and identified by the edrap_ref_rap_id[i] syntax elements.

The constraints indicated by the presence of the EDRAP indication SEI message, which shall all apply, are as follows:
The EDRAP picture is a trailing picture.
The EDRAP picture has a temporal sublayer identifier equal to 0.
The EDRAP picture does not include any pictures in the same layer in the active entries of its reference picture lists except the referenceablePictures.
Any picture that is in the same layer and follows the EDRAP picture in both decoding order and output order does not include, in the active entries of its reference picture lists, any picture that is in the same layer and precedes the EDRAP picture in decoding order or output order, with the exception of the referenceablePictures.
Any picture in the list referenceablePictures does not include, in the active entries of its reference picture lists, any picture that is in the same layer and is not a picture at an earlier position in the list referenceablePictures.

NOTE—Consequently, the first picture in referenceablePictures, even when it is an EDRAP picture instead of an IRAP picture, does not include any picture from the same layer in the active entries of its reference picture lists.

edrap_rap_id_minus1 plus 1 specifies the RAP picture identifier, denoted as RapPicId, of the EDRAP picture.

Each IRAP or EDRAP picture is associated with a RapPicId value. The RapPicId value for an IRAP picture is inferred to be equal to 0. The RapPicId values for any two EDRAP pictures associated with the same IRAP picture shall be different.

edrap_leading_pictures_decodable_flag equal to 1 specifies that both of the following constraints apply:
Any picture that is in the same layer and follows the EDRAP picture in decoding order shall follow, in output order, any picture that is in the same layer and precedes the EDRAP picture in decoding order.
Any picture that is in the same layer and follows the EDRAP picture in decoding order and precedes the EDRAP picture in output order shall not include, in the active entries of its reference picture lists, any picture that is in the same layer and precedes the EDRAP picture in decoding order, with the exception of the referenceablePictures.

edrap_leading_pictures_decodable_flag equal to 0 does not impose such constraints.

edrap_reserved_zero_12bits shall be equal to 0 in bitstreams conforming to this version of this Specification. Other values for edrap_reserved_zero_12bits are reserved for future use by ITU-T|ISO/IEC. Decoders shall ignore the value of edrap_reserved_zero_12bits.

edrap_num_ref_rap_pics_minus1 plus 1 indicates the number of IRAP or EDRAP pictures that are within the same CLVS as the EDRAP picture and may be included in the active entries of the reference picture lists of the EDRAP picture.

edrap_ref_rap_id[i] indicates RapPicId of the i-th RAP picture that may be included in the active entries of the reference picture lists of the EDRAP picture. The i-th RAP picture shall be either the IRAP picture associated with the current EDRAP picture or an EDRAP picture associated with the same IRAP picture as the current EDRAP picture.

### 2.5.3. The EDRAP Sample Group and Associated External Stream Track Reference.

An amendment to the ISOBMFF standard is being developed. The latest draft specification of this amendment includes the specifications of the EDRAP sample group and the associated external stream track reference.

The specifications of these two ISOBMFF features are as follows.

### 3.1 Definitions

EDRAP sample—sample for which all subsequent samples in both decoding and output order can be correctly decoded provided that the closest preceding SAP sample of type 1, 2, or 3 and zero or more preceding EDRAP samples are available when decoding the sample and the subsequent samples.

Note 1 to entry. The closest preceding SAP sample of type 1, 2, or 3 and the zero or more preceding EDRAP samples as described above are referred to as the required preceding SAP and EDRAP samples of the EDRAP sample.

Random access-decoding of an elementary stream starting from a particular access unit without decoding of any access unit in the elementary stream earlier in decoding order

Note 1 to entry. Sync samples and SAPs provide random accessing capabilities.

### 3.2 Abbreviated Terms

EDRAP extended dependent random access point

### 8.3.3.4 Associated External Stream Track Reference.

A track reference of type ‘aest’ (meaning “associated external stream track”) may be included in a video track.

When a video track has a track reference of type ‘aest’, the following applies:
The video track should have at least one sample associated with an EDRAP sample group.
The referenced track shall comply to the following constraints:
Each sample in the referenced track shall be identified as a sync sample.
The referenced track shall have both header flags track_in_movie and track_in_preview equal to 0.
The referenced track shall use a restricted scheme, as follows:
The scheme_type field in the SchemeTypeBox, which is in the RestrictedSchemeInfoBox, is equal to ‘tspt’ and the value of the mode field in the SamplePackingInformationBox is equal to 1.
Bit 0 of the flags field of the SchemeTypeBox is equal to 0, such that the value of (flags & 0x000001) is equal to 0.

For each sample sampleA in the video track associated with an EDRAP sample group, there shall be one and only one sample sampleB in the referenced track that has the same decoding time as sampleA, and a number of consecutive samples in the referenced track, starting from sampleB, shall contain all media data of the required preceding SAP and EDRAP samples of sampleA. The consecutive samples in the referenced track shall precede sampleC corresponding to another sample in the video track associated with an EDRAP sample group.

### 8.20 Transformed Sample-Packed Tracks

### 8.20.1 Introduction

When a restricted scheme with SchemeType ‘tspt’ is in use for a track, a sample associated with the sample entry may contain more than one sample of an original track, on which a transformation has been applied to produce the current track. Such a current track is referred to as a sample-packed track.

### 8.20.2 Transformed Sample Packing Information Box.

### 8.20.2.1 Definition

Box Type: ‘tspi’
Container: SchemeInformationBox
Mandatory: Yes (when the SchemeType is ‘tspt’)
Quantity: One

### 8.20.2.2 Syntax

aligned(8) class TransformedSamplePackingInformationBox extends FullBox(‘tspi’, version = 0, flags =
0)
{
unsigned int(8) mode;
}

### 8.20.2.3 Semantics

mode equal to 0 specifies that all the samples of the original streams have been preserved in the transformation. The value 1 specifies that only some samples have been preserved. All other values are reserved for future use.

10.11 Extended DRAP (EDRAP) sample group

### 10.11.1 Definition

The EDRAP sample group documents the EDRAP samples in a track. This sample group is similar to the DRAP sample group as specified in subclause 10.8; however, it enables signalling additional samples, that can also be used for random access but that have more complex dependencies.

NOTE 1: Similarly as for DRAP samples, EDRAP samples can only be used in combination with SAP samples of type 1, 2 and 3.

NOTE 2: A DRAP sample is always an EDRAP sample.

### 10.11.2 Syntax

```
class VisualEdrapEntry( )
extends VisualSampleGroupEntry(‘edrp’) {
  unsigned int(3) edrap_type;
  unsigned int(3) num_ref_edrap_pics;
  unsigned int(26) reserved = 0;
  for(i=0; i<num_ref_edrap_pics; i++)
    unsigned int(16) ref_edrap_idx_delta[i];
}
```

### 10.11.3 Semantics

edrap_type is a non-negative integer. When edrap_type is in the range of 1 to 3 it indicates the SAP_type (as specified in Annex I) that the EDRAP sample would have corresponded to, had it not depended on the closest preceding SAP or other EDRAP samples. Other type values are reserved.

num_ref_edrap_pics indicates the number of other EDRAP samples that are earlier in decoding order than the EDRAP sample and are needed for reference to be able to correctly decode the EDRAP sample and all samples following the EDRAP sample in both decoding and output order when starting decoding from the EDRAP sample.

NOTE: an EDRAP sample which is also a DRAP sample would have num_ref_edrap_pics set to 0. reserved shall be equal to 0. The semantics of this subclause only apply to sample group description entries with reserved equal to 0. Parsers shall allow and ignore sample group description entries with reserved greater than 0 when parsing this sample group.

ref_edrap_idx_delta[i] indicates the i-th required preceding EDRAP sample of the current EDRAP sample. Let the list of EDRAP samples associated with a SAP sample of type 1, 2 or 3 be all the EDRAP samples following the SAP sample and preceding the next SAP sample, when present. The EDRAP sample index is defined as the index to this list of EDRAP samples. The value of ref_edrap_idx_delta[i] is equal to the EDRAP sample index of the current EDRAP sample and the EDRAP sample index of the i-th required preceding EDRAP sample. The value 1 indicates that the i-th EDRAP sample is the last EDRAP sample preceding this EDRAP sample in decoding order, the value 2 indicates that the i-th EDRAP sample is the second last EDRAP sample preceding this EDRAP sample in decoding order, and so on.

### 3. Problems

Existing designs of the DRAP sample group and the EDRAP sample group have the following problems:

1) For the DRAP sample group, when random accessing from a DRAP sample sampleA, a parameter set, e.g., a picture parameter set (PPS) for AVC, HEVC, or VVC, or an adaptation parameter set (APS) for VVC, that is needed for decoding sampleA or a sample following sample A in both decoding and output order may be present in a sample sampleB that is between the closest preceding SAP sample of type 1, 2, or 3 and sampleA. In that case, to able to decode sampleA, not only the SAP sample is needed, but also sampleB (at least part of it) is needed.

2) For the EDRAP sample group, when random accessing from an EDRAP sample sampleA, a parameter set, e.g., a picture parameter set (PPS) for AVC, HEVC, or VVC, or an adaptation parameter set (APS) for VVC, that is needed for decoding sampleA or a sample following sample A in both decoding and output order may be present in a sample sampleB that is between the closest preceding SAP sample of type 1, 2, or 3 and sampleA and is not one of the required preceding EDRAP samples. In that case, to able to decode sampleA, not only the required SAP and EDRAP samples are needed, but also sampleB (at least part of it) is needed.

### 4. Solutions to the Problems

To solve the above problems, methods as summarized below are disclosed. The inventions should be considered as examples to explain the general concepts and should not be interpreted in a narrow way. Furthermore, these inventions can be applied individually or combined in any manner.

1) To solve the first problem, the following constraint is specified:

The following applies for any DRAP sample sampleA that is mapped to a DRAP sample group:
Let sampleSeq be a sequence of samples consisting of the following samples in the order of the bullets below:
the closest preceding SAP sample of type 1, 2, or 3,
sampleA, and
all samples following sampleA in both decoding and output order in the track.
For each sample sampleB in sampleSeq, all data needed for processing sampleB shall be

accessible in the referenced sample entry, in sampleB itself, or in any sample that precedes sampleB in decoding order and is present in sampleSeq.

NOTE: For some video codecs, all data needed for processing a sample sampleB includes parameter sets needed for decoding sampleB.

2) To solve the second problem, the following constraint is specified:

The following applies for any EDRAP sample sampleA that is mapped to an EDRAP sample group:
Let sampleSeq be a sequence of samples consisting of the following samples in the order of the bullets below:
the closest preceding SAP sample of type 1, 2, or 3,
the EDRAP samples identified by ref_edrap_idx_delta[i] for i in the range of 0 to num_ref_edrap_samples−1, inclusive, in decoding order,
sampleA, and
all samples following sampleA in both decoding and output order in the track.
For each sample sampleB in sampleSeq, all data needed for processing sampleB shall be accessible in the referenced sample entry, in sampleB itself, or in any sample that precedes sampleB in decoding order and is present in sampleSeq.

NOTE: For some video codecs, all data needed for processing a sample sampleB includes parameter sets needed for decoding sampleB.

### Embodiments

Below are some example embodiments for some of the invention aspects summarized above in Section 5. Most relevant parts that have been added or modified are in italics. There may be some other changes that are editorial in nature and thus not highlighted.

### 5.1. First Embodiment

This embodiment is for the solutions in items 1 and 2.

### 3.1 Definitions

### EDRAP Sample

sample for which all subsequent samples in both decoding and output order can be correctly decoded provided that the closest preceding SAP sample of type 1, 2, or 3 and zero or more preceding EDRAP samples are available when decoding the sample and the subsequent samples

Note 1 to entry The closest preceding SAP sample of type 1, 2, or 3 and the zero or more preceding EDRAP samples as described above are referred to as the required preceding SAP and EDRAP samples of the EDRAP sample.

### 10.8 Dependent Random Access Point (DRAP) Sample Group

### 10.8.1 Definition

A dependent random access point (DRAP) sample is a sample after which all samples in decoding order and in output order can be correctly decoded if the closest preceding SAP sample of type 1, 2, or 3 is available for reference.

NOTE 1 The closest SAP sample can be a Sync sample or marked by the SAP sample group.

NOTE 2 DRAP samples can only be used in combination with SAP samples of type 1, 2 and 3. This is in order to enable the functionality of creating a decodable sequence of samples by concatenating the preceding SAP sample with the DRAP sample and the samples following the DRAP sample in decoding order and in output order.

The following applies for any DRAP sample sampleA that is mapped to a DRAP sample group:
Let sampleSeq be a sequence of samples consisting of the following samples in the order of the bullets below:
the closest preceding SAP sample of type 1, 2, or 3,
sampleA, and
all samples following sampleA in both decoding and output order in the track.
For each sample sampleB in sampleSeq, all data needed for processing sampleB shall be accessible in the referenced sample entry, in sampleB itself, or in any sample that precedes sampleB in decoding order and is present in sampleSeq.

NOTE 3 For some video codecs, all data needed for processing a sample sampleB includes parameter sets needed for decoding sampleB.

### 10.8.2 Syntax.

```
class VisualDRAPEntry( )
extends VisualSampleGroupEntry(‘drap’) {
  unsigned int(3) DRAP_type;
  unsigned int(29) reserved = 0;
}
```

### 10.8.3 Semantics.

DRAP_type is a non-negative integer. When DRAP_type is in the range of 1 to 3 it indicates the SAP_type (as specified in Annex I) that the DRAP sample would have corresponded to, had it not depended on the closest preceding SAP. Other type values are reserved.

reserved shall be equal to 0. The semantics of this subclause only apply to sample group description entries with reserved equal to 0. Parsers shall allow and ignore sample group description entries with reserved greater than 0 when parsing this sample group.

### 10.11 Extended DRAP (EDRAP) Sample Group

### 10.11.1 Definition

The EDRAP sample group documents the EDRAP samples in a track. This sample group is similar to the DRAP sample group as specified in subclause 10.8; however, it enables signalling additional samples that can also be used for random access but have more flexible dependencies. When a track has a SampleToGroupBox with grouping_type equal to ‘edrp’, each EDRAP sample in the track shall be a member of an EDRAP sample group.

NOTE 1: Similarly as for DRAP samples, EDRAP samples can only be used in combination with SAP samples of type 1, 2 and 3.

NOTE 2: A DRAP sample is always an EDRAP sample.

### 10.11.2 Syntax

```
class VisualEdrapEntry( )
extends VisualSampleGroupEntry(‘edrp’) {
  unsigned int(3) edrap_type;
  unsigned int(3) num_ref_edrap_samples;
  unsigned int(26) reserved = 0;
  for(i=0; i<num_ref_edrap_samples; i++)
    unsigned int(16) ref_edrap_idx_delta[i];
}
```

### 10.11.3 Semantics

edrap_type is a non-negative integer. When edrap_type is in the range of 1 to 3 it indicates the SAP_type (as specified in Annex I) that the EDRAP sample would have corresponded to, had it not depended on the closest preceding SAP or other EDRAP samples. Other type values are reserved.

NOTE 1 An EDRAP sample and all the subsequent samples in the same track may depend on the closest preceding SAP and/or some preceding EDRAP samples and does not depend on any other samples preceding the EDRAP sample. Therefore, if the encoder chooses to encode an EDRAP sample such that it does not depend on the closest preceding SAP or any preceding EDRAP sample, then the EDRAP sample becomes a SAP.

num_ref_edrap_samples indicates the number of other EDRAP samples that are earlier in decoding order than the EDRAP sample and are needed for reference to be able to correctly decode the EDRAP sample and all samples following the EDRAP sample in both decoding and output order when starting decoding from the EDRAP sample.

NOTE 2 An EDRAP sample that is also a DRAP sample would have num_ref_edrap_samples equal to 0.

reserved shall be equal to 0. The semantics of this subclause only apply to sample group description entries with reserved equal to 0. Parsers shall allow and ignore sample group description entries with reserved greater than 0 when parsing this sample group.

ref_edrap_idx_delta[i] indicates the i-th required preceding EDRAP sample of the current EDRAP sample. Let the list of EDRAP samples associated with a SAP sample of type 1, 2 or 3 be all the EDRAP samples following the SAP sample and preceding the next SAP sample, when present. The EDRAP sample index is defined as the index to this list of EDRAP samples. The value of ref_edrap_idx_delta[i] is equal to the EDRAP sample index of the current EDRAP sample and the EDRAP sample index of the i-th required preceding EDRAP sample. The value 1 indicates that the i-th EDRAP sample is the last EDRAP sample preceding this EDRAP sample in decoding order, the value 2 indicates that the i-th EDRAP sample is the second last EDRAP sample preceding this EDRAP sample in decoding order, and so on.

The following applies for any EDRAP sample sampleA that is mapped to an EDRAP sample group:
Let sampleSeq be a sequence of samples consisting of the following samples in the order of the bullets below:
the closest preceding SAP sample of type 1, 2, or 3,
the EDRAP samples identified by ref_edrap_idx_delta[i] for i in the range of 0 to num_ref_edrap_samples−1, inclusive, in decoding order,
sampleA, and
all samples following sampleA in both decoding and output order in the track.
For each sample sampleB in sampleSeq, all data needed for processing sampleB shall be accessible in the referenced sample entry, in sampleB itself, or in any sample that precedes sampleB in decoding order and is present in sampleSeq.

NOTE 3 For some video codecs, all data needed for processing a sample sampleB includes parameter sets needed for decoding sampleB.

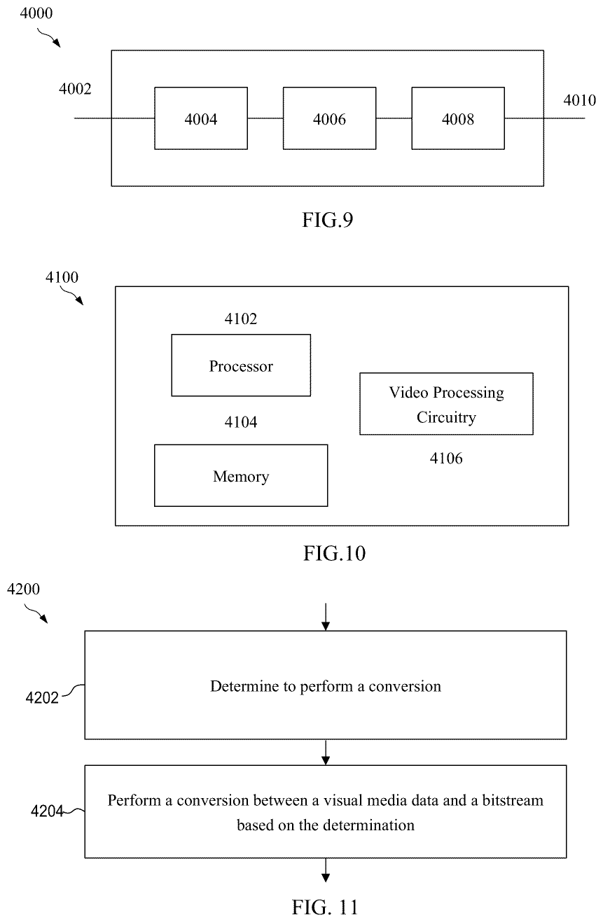

FIG. 9 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 10 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 11 is a flowchart for an example method 4200 of video processing. The method 4200 includes determining to perform a conversion at step 4202, such as a conversion between a visual media data and a bitstream. In one embodiment, determining to perform the conversion in step 4202 may include generating a sequence of samples (sampleSeq) comprising a closest preceding SAP of type 1, type 2, or type 3, a first DRAP sample (sampleA), and all samples following the first DRAP sample in both decoding order and output order in a track including at least one second DRAP sample (sampleB). Determining to perform the conversion in step 4202 may also include ensuring, for each of the second DRAP samples in the sequence of samples, that all data for processing the second DRAP sample is accessible in a referenced sample entry, in the second DRAP sample itself, or in one of the samples preceding the second DRAP sample in decoding order and present in the sequence of samples.

In another embodiment, determining to perform the conversion in step 4202 may include generating a sequence of samples (sampleSeq) comprising a closest preceding SAP of type 1, type 2, or type 3, a first EDRAP sample (sampleA) identified by ref_edrap_idx_delta[i] for i in the range of 0 to num_ref_edrap_samples−1, inclusive, in decoding order, and all samples following the first EDRAP sample in both decoding order and output order in a track including at least one second EDRAP sample (sampleB). In this embodiment, determining to perform the conversion in step 4202 may also include ensuring, for each of the second EDRAP samples in the sequence of samples, that all data for processing the second EDRAP sample is accessible in a referenced sample entry, in the second EDRAP sample itself, or in one of the samples preceding the second EDRAP sample in decoding order and present in the sequence of samples.

Regardless of the particular embodiment implemented by step 4202, the method continues to step 4204, in which a conversion is performed between the visual media data and the bitstream based on the determination of step 4202. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

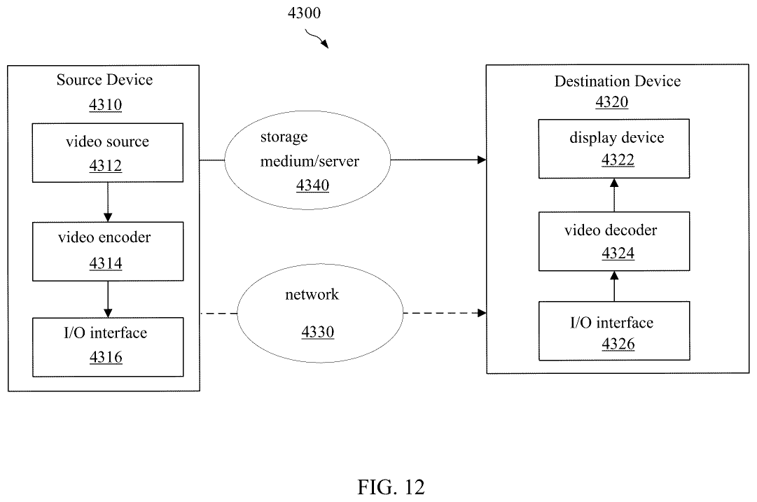

FIG. 12 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

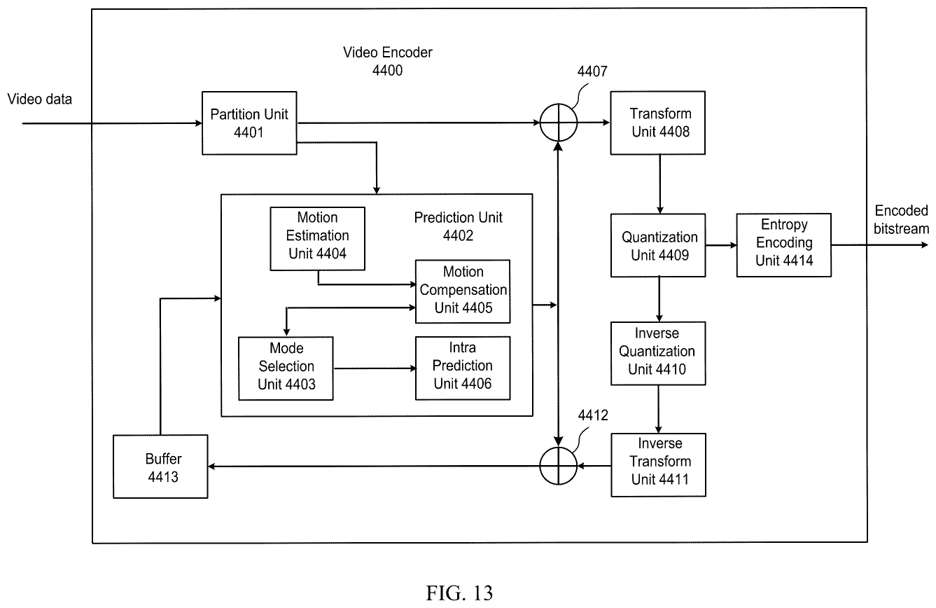

FIG. 13 is a block diagram illustrating an example of video encoder 4400, which may be video encoder 4314 in the system 4300 illustrated in FIG. 12. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

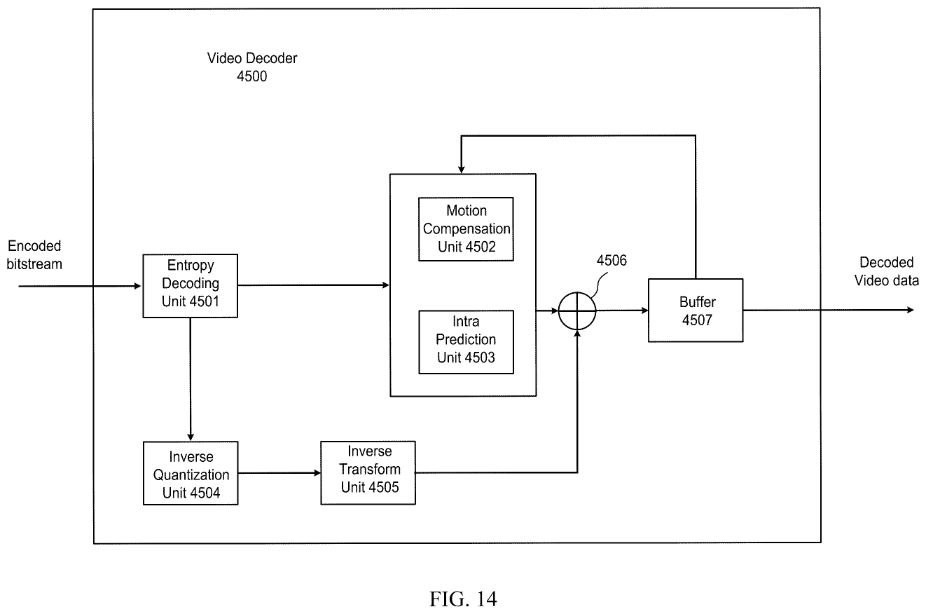

FIG. 14 is a block diagram illustrating an example of video decoder 4500 which may be video decoder 4324 in the system 4300 illustrated in FIG. 12. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

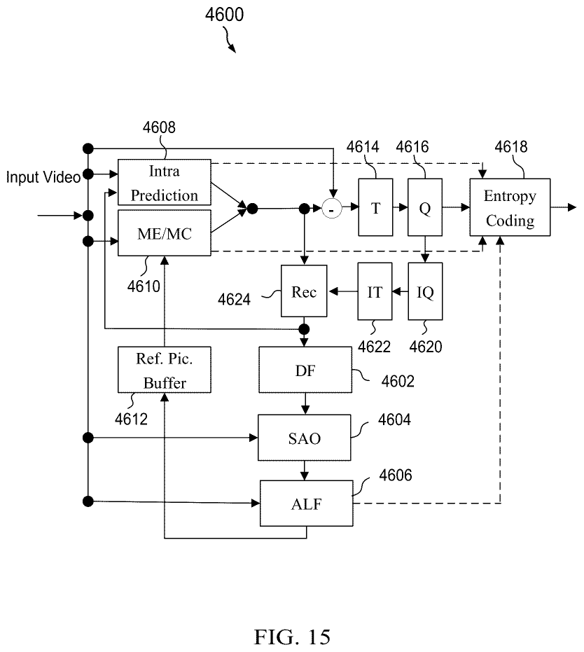

FIG. 15 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.

1. A method of processing video data, comprising: generating a sequence of samples (sampleSeq) comprising a closest preceding stream access point (SAP) of type 1, type 2, or type 3, a first dependent random access point (DRAP) sample (sampleA), and all samples following the first DRAP sample in both decoding order and output order in a track including at least one second DRAP sample (sampleB); ensuring, for each of the second DRAP samples in the sequence of samples, that all data for processing the second DRAP sample is accessible; and performing a conversion between a video comprising the video data and a bitstream of the video data based on the data.

2. The method of claim 1, wherein the first DRAP sample is mapped to a DRAP sample group.

3. The method of any of claims 1-2, wherein all data for processing the second DRAP sample is accessible in a referenced sample entry.

4. The method of any of claims 1-2, wherein all data for processing the second DRAP sample is accessible in the second DRAP sample itself.

5. The method of any of claims 1-2, wherein all data for processing the second DRAP sample is accessible in one of the samples preceding the second DRAP sample in decoding order and present in the sequence of samples.

6. The method of any of claims 1-5, wherein all data for processing the second DRAP sample comprises parameter sets for decoding the second DRAP sample.

7. A method of processing video data, comprising: generating a sequence of samples (sampleSeq) comprising a closest preceding stream access point (SAP) of type 1, type 2, or type 3, a first extended dependent random access point (EDRAP) sample (sampleA) identified by ref_edrap_idx_delta[i] for i in the range of 0 to num_ref_edrap_samples−1, inclusive, in decoding order, and all samples following the first EDRAP sample in both decoding order and output order in a track including at least one second EDRAP sample (sampleB); ensuring, for each of the second EDRAP samples in the sequence of samples, that all data for processing the second EDRAP sample is accessible; and performing a conversion between a video comprising the video data and a bitstream of the video data based on the data.

8. The method of claim 7, wherein the first EDRAP sample is mapped to an EDRAP sample group.

9. The method of any of claims 7-8, wherein all data for processing the second EDRAP sample is accessible in a referenced sample entry.

10. The method of any of claims 7-8, wherein all data for processing the second EDRAP sample is accessible in the second EDRAP sample itself.

11. The method of any of claims 7-8, wherein all data for processing the second EDRAP sample is accessible in one of the samples preceding the second EDRAP sample in decoding order and present in the sequence of samples.

12. The method of any of claims 7-11 wherein all data for processing the second EDRAP sample comprises parameter sets for decoding the second EDRAP sample.

13. An apparatus for processing video data comprising: a processor; and a non-transitory memory with instructions thereon, wherein the instructions upon execution by the processor, cause the processor to perform the method of any of claims 1-12.

14. A non-transitory computer readable medium comprising a computer program product for use by a video coding device, the computer program product comprising computer executable instructions stored on the non-transitory computer readable medium such that when executed by a processor cause the video coding device to perform the method of any of claims 1-12.

15. A non-transitory computer-readable recording medium storing a bitstream of a video which is generated by a method performed by a video processing apparatus, wherein the method comprises the method of any of claims 1-12.

16. A method for storing bitstream of a video comprising the method of any of claims 1-12, wherein performing the conversion between the video comprising the video data and the bitstream of the video data comprises generating the bitstream, and wherein the method further comprises storing the bitstream in a non-transitory computer-readable recording medium.

17. A method, apparatus, or system described in the present document.

In the solutions described herein, an encoder may conform to a format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The solutions listed in the present disclosure might be used for compressing an image, compressing a video, compression part of an image or compressing part of a video.

In addition, techniques, systems, subsystems, and methods described and illustrated in the various embodiments might be used for compressing an image, compressing a video, compression part of an image or compressing part of a video.

What is claimed is:

1. A method of processing media data, comprising:
determining, for a dependent random access point (DRAP) sample, a first sequence of samples; and
performing a conversion between media data and a media data file based on the determining,
wherein the first sequence of samples consists of the following samples in an order listed below:
1) a closest preceding stream access point (SAP) sample of type 1, type 2, or type 3;
2) the DRAP sample; and
3) all samples following the DRAP sample in both decoding order and output order in a first track.

2. The method of claim 1, wherein the DRAP sample is mapped to a DRAP sample group.

3. The method of claim 1, wherein for a first sample in the first sequence of samples, all data needed for processing the first sample shall be accessible in a first referenced sample entry, in the first sample itself, or in any sample that precedes the first sample in decoding order and is present in the first sequence of samples.

4. The method of claim 1, wherein for some video codecs, all data for processing a third sample in the first sequence of samples comprises parameter sets needed for decoding the third sample.

5. The method of claim 1, further comprising:
determining, for an extended dependent random access point (EDRAP) sample, a second sequence of samples,
wherein for a fourth sample in the second sequence of samples, all data needed for processing the fourth sample shall be accessible in a second referenced sample entry, in the fourth sample itself, or in any sample that precedes the fourth sample in decoding order and is present in the second sequence of samples.

6. The method of claim 5, wherein the EDRAP sample is mapped to an EDRAP sample group.

7. The method of claim 5, wherein for some video codecs, all data for processing a fifth sample in the second sequence of samples comprises parameter sets needed for decoding the fifth sample.

8. The method of claim 5, wherein the second sequence of samples consists of the following samples in an order listed below:
1) SAP or EDRAP samples identified by index syntax elements in decoding order;
2) the EDRAP sample; and
3) all samples following the EDRAP sample in both decoding order and output order in a second track.

9. The method of claim 1, wherein the DRAP sample is a sample after which all samples in decoding order and in output order can be correctly decoded if a closest SAP sample of type 1, type 2, or type 3 preceding the DRAP sample is available for reference.

10. The method of claim 1, wherein DRAP samples are only used in combination with SAP samples of type 1, type 2, and type 3.

11. The method of claim 1, wherein the conversion comprises generating the media data file from the media data.

12. The method of claim 1, wherein the conversion comprises parsing the media data from the media data file.

13. An apparatus for processing media data comprising: a processor; and a non-transitory memory with instructions thereon, wherein the instructions upon execution by the processor, cause the processor to:
determine, for a dependent random access point (DRAP) sample, a first sequence of samples; and
perform a conversion between media data and a media data file based on the determining,
wherein the first sequence of samples consists of the following samples in an order listed below:
1) a closest preceding stream access point (SAP) sample of type 1, type 2, or type 3;
2) the DRAP sample; and
3) all samples following the DRAP sample in both decoding order and output order in a first track.

14. The apparatus of claim 13, wherein the DRAP sample is mapped to a DRAP sample group.

15. The apparatus of claim 13, wherein for a first sample in the first sequence of samples, all data needed for processing the first sample shall be accessible in a first referenced sample entry, in the first sample itself, or in any sample that precedes the first sample in decoding order and is present in the first sequence of samples.

16. A non-transitory computer-readable storage medium storing instructions that cause a processor to:
determine, for a dependent random access point (DRAP) sample, a first sequence of samples; and
perform a conversion between media data and a media data file based on the determining,
wherein the first sequence of samples consists of the following samples in an order listed below:
1) a closest preceding stream access point (SAP) sample of type 1, type 2, or type 3;
2) the DRAP sample; and
3) all samples following the DRAP sample in both decoding order and output order in a first track.

17. The non-transitory computer-readable storage medium of claim 16, wherein the DRAP sample is mapped to a DRAP sample group.

18. The non-transitory computer-readable storage medium of claim 16, wherein for a first sample in the first sequence of samples, all data needed for processing the first sample shall be accessible in a first referenced sample entry, in the first sample itself, or in any sample that precedes the first sample in decoding order and is present in the first sequence of samples.

19. A non-transitory computer-readable recording medium storing a media data file which is generated by a method performed by a video processing apparatus, wherein the method comprises:
determining, for a dependent random access point (DRAP) sample, a first sequence of samples; and
generating the media data file based on the determining,
wherein the first sequence of samples consists of the following samples in an order listed below:
1) a closest preceding stream access point (SAP) sample of type 1, type 2, or type 3;
2) the DRAP sample; and
3) all samples following the DRAP sample in both decoding order and output order in a first track.

20. The non-transitory computer-readable recording medium of claim 19, wherein the DRAP sample is mapped to a DRAP sample group.
